(19) United States
(12) Patent Application Publication
(10) Pub. No.: US 2020/0294156 A1
(43) Pub. Date: Sep. 17, 2020

(54) System and Method for Invoicing, Financing, and Payments Exchange

(71) Applicant: CoreChain Technologies, Inc., Weston, CT (US)

(72) Inventor: Christopher P. Aguas, Weston, CT (US)

(21) Appl. No.: 16/814,668

(22) Filed: Mar. 10, 2020

Related U.S. Application Data
(60) Provisional application No. 62/816,657, filed on Mar. 11, 2019.

(51) Int. Cl. G06Q 40/00; G06Q 30/06; G06Q 40/08; G06Q 10/10; G06Q 30/00; G06Q 40/02; G06Q 10/08; G06Q 50/18; G06Q 30/04; G06Q 20/38; G06F 16/23; G06F 16/27; G06F 21/60

(52) U.S. Cl. CPC G06Q 40/12; G06Q 30/0635; G06Q 40/08; G06Q 10/10; G06Q 30/012; G06Q 40/025; G06Q 2220/00; G06Q 50/18; G06Q 30/04; G06Q 20/389; G06F 16/2379; G06F 16/27; G06F 21/602; G06Q 10/0838

(57) ABSTRACT

A system facilitating purchase and sales transactions is disclosed, having a computer, a ledger database in data communication with said computer, a transaction received by said computer, software executing on said computer for recording the transaction on the ledger, a notification indicative of the transaction transmitted by said computer to at least one counterparty, an update indicative of a change to the transaction received by said computer, software executing on said computer for relating the update with the transaction, software executing on said computer for recording the update on the ledger in a manner relating it to the transaction, and a second notification indicative of the updated transaction transmitted by said computer to at least one counterparty.

### TECHNICAL FIELD

The present invention generally relates to invoicing, financing, and payments exchange, and more specifically to a system facilitating purchase and sales transactions.

### BACKGROUND

Invoicing, financing, and paying for purchase and sale transactions generally occurs in discrete stages. At each stage of the transaction, documentation is generated and actions are taken that need to be reconciled between the counterparties (e.g., buyer and supplier). Reconciliation can be costly and time consuming due to its repetitive and redundant nature. In addition, involving third parties in transactions to provide financial, shipping, or other services can require additional documentation reconciliation and verification, compounding the problem.

The lack of interconnection between the physical movement of goods, services, funds, and related transaction data for both buyers and suppliers, the lack of a common system of record between buyers and suppliers, and the extensive reliance on manual and analog processes gives rise to constant duplication of effort and the need for endless, time consuming, and laborious reconciliation by all parties at every stage.

For example, in some business to business transactions, a purchase order is sent from a buyer to a supplier, typically as a physical document or representation thereof (e.g., PDF). The supplier reviews the purchase order and records it in its own internal system. Assuming the purchase order is acceptable, the supplier will next send the goods to the buyer with a shipping memo. The buyer must inspect the goods for accuracy versus the purchase order and record the same in its own internal system. The supplier then invoices the buyer for the goods sold, and the buyer must reconcile the invoice with the purchase order and shipping memo. Once reconciled, the buyer makes payment, which the supplier must again record and reconcile. At each stage in this example, the buyer and supplier repeat a costly process, the only goal of which is to ensure the completion of the transaction.

Adding to this example, the supplier may have sought an accelerated payment loan from a third-party financer to manufacture the goods. Alternatively, a buyer may wish to finance its purchase. Currently, the third-party financer would want to complete “know your customer” steps, including verifying the transaction, including by calling the counterparty to determine the authenticity of any documentation, including a purchase order, past payment history, etc. Any information the third-party financer can learn about this and past transactions between the counterparties can help it assess risk and reduce its costs. However, the only way to currently obtain this information is directly from the buyer and supplier, adding cost.

Therefore, there exists a need for a system that facilitates purchase and sale transactions. Moreover, there is a need for such a system to provide information to third parties that counterparties to a transaction agree is truthful, and that third parties can verify.

### SUMMARY

An object of the invention is to provide a system for facilitating invoicing, financing, and payments exchange.

It is a further object of the invention to facilitate purchase and sale transactions, including facilitating the exchange of documents between counterparties.

It is a further object of the invention to provide a common system of record for counterparties.

It is a further object of the invention to reduce the duplication of effort regarding reconciliation between counterparties.

It is another object of the invention to provide a system by which counterparties to a purchase and sale transaction trust the records of the transaction as true.

In addition, it is an object of the invention to provide a system by which third parties to a purchase and sale transaction trust the system as providing true records accepted by the counterparties.

In one aspect of the invention, a system facilitating purchase and sales transactions is disclosed, having a computer, a ledger database in data communication with said computer, a transaction received by said computer, software executing on said computer for recording the transaction on the ledger, a notification indicative of the transaction transmitted by said computer to at least one counterparty, an update indicative of a change to the transaction received by said computer, software executing on said computer for relating the update with the transaction, software executing on said computer for recording the update on the ledger in a manner relating it to the transaction, and a second notification indicative of the updated transaction transmitted by said computer to at least one counterparty.

Further, the system may include an authorization regarding a third-party is received by the computer. In addition, the system may further have software executing on said computer for providing at least one of the transaction or the updated transaction to the third-party.

Other embodiments of the system are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic diagram of the presently disclosed system.

FIG. 2 is a schematic diagram of the presently disclosed system.

FIG. 3 is a flow chart for using the presently disclosed system.

FIG. 4 is a flow chart for using the presently disclosed system.

FIG. 5 is a user interface for using the presently disclosed system.

### DETAILED DESCRIPTION

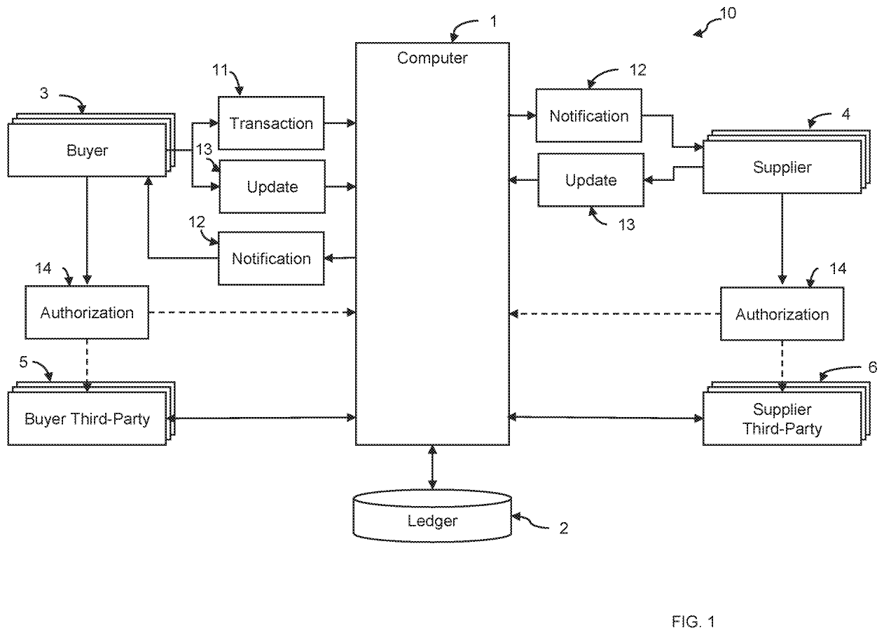

Referring to FIG. 1, the present disclosure describes a system 10 for facilitating purchase and sale transactions.

The system 10 includes a computer 1. The computer 1 may be a processor, remote computer, computer server, network, or any other typical computing resource.

A ledger 2 is in data communication with the computer 1. The ledger 2 may include any decentralized and distributed digital database resistant to the modification of data. The ledger 2 may include a public blockchain, a private blockchain, or a hybrid blockchain.

The computer 1 receives a transaction 11 from a buyer 3. The transaction 11 includes information regarding the state of the transaction. For instance, the transaction 11 received from the buyer 3 may identify the counterparties (including the buyer 3 and supplier 4) and any third-parties 5, 6, such as shipping companies or financers. The transaction 11 may also include information indicative of a start of a transaction, including a request for proposal, a request for information, and a purchase order. The transaction 11 may also be further along, and contain other documents or information regarding completing the transaction. Any information provided as part of transaction 11 can in any electronic form, such as in a computer document, spreadsheet, PDF, XML file, or other way of electronically storing information. The transaction 11 is shown as being received from buyer 3 in FIG. 1, but can be received from any counterparty, including supplier 4.

The computer 1 records the transaction 11 to the ledger 2. Prior to recordation, the transaction 11 may be encrypted, for example, to keep details of the transaction confidential to the counterparties 3, 4. Encryption may be performed using any known cryptographic method, including public/private key cryptography. Preferably, the counterparties 3, 4 generate, exchange, or use known cryptographic keys to encrypt and decrypt any information provided to the computer 1. For example, a transaction 11 provided by the buyer 3 can be encrypted using the buyer's private key and the supplier's public key. Also preferably, the computer 1 can perform all encryption and decryption by generating, storing, recalling, and using all necessary keys, or by using keys provided by the counterparties. In this way, encryption and decryption can be transparent to the counterparties 3, 4. Along with the transaction 11, any other information, such as a buyer identity, a supplier identity, third-party authorization, and/or timestamps may also be recorded on the ledger 2.

The computer 1 sends a notification 12 that the transaction 11 has been recorded to at least one counterparty 3, 4. The notification 12 may be sent based on the transaction 11, or at the request of a counterparty 3, 4. The notification 12 may include different content based on the transaction 11 or a state thereof. For example, the notification 12 may inform the counterparties that an action is required, such as by requesting that a counterparty (in FIG. 1, supplier 4) accept or reject the transaction 11 as recorded, ship goods, or initiate payment. A notification 12 need not be immediately sent. For example, a notification 12 may be viewable at a set time, or at the request of a counterparty 3, 4.

A counterparty 3, 4 may send an update 13 to the computer 1 regarding the transaction 11. The update 13 is indicative of an updated state of transaction 11, different from a previous state. The update 13 may be accompanied by documents or information, including a change order, a line of credit, a quote, a shipping confirmation, a shipping memorandum, a delivery confirmation, an insurance document, a risk of loss document, an invoice, a request for payment, a payment confirmation, a payment, and a warranty. The update 13 is recorded on the ledger 2 by the computer 1 in a manner relating it to transaction 11 or another previously recorded update 13. The update 13 may be recorded with additional information, such as a timestamp.

The update 13 may include an acceptance or rejection of a previous state of the transaction. In the case of an acceptance, the transaction may proceed normally. In the case of a rejection, the rejecting counterparty may seek to propose an alternative term. The computer may send a notification 12 to at least one counterparty 3, 4 that the update 13 has been recorded. The notification 12 may be sent based on the update 13, or at the request of a counterparty 3, 4. The notification 12 may include different content based on the update 13. The notification 12 may be subject to the same rules as a notification 12 of a transaction 11, as discussed above.

For example, a supplier 4 may receive a notification 12 regarding a transaction 11 including a purchase order from a buyer 3 at a lower price per unit than the supplier wishes to provide. The supplier 4 may provide an update 13 to the computer 1 indicative of a change order, setting a different price per unit. The buyer 3 receives a notification 12 regarding the update 13, and will have the opportunity to accept or reject the new price per unit by providing a new update 13 to the computer 1.

As the transaction 11 moves towards completion, each state of the transaction 11, including any updates 13, are related on the ledger 2 and therefore can easily be accessed and viewed as a whole. Moreover, since the parties are causing their own documents and acceptances to be recorded, the trustworthiness of the ledger 2 is guaranteed.

The counterparties may record multiple transactions 11, which may be related on the ledger 2. For example, a new transaction 11 may be used for each new purchase and sale transaction. By relating multiple transactions 11, a history of transactions between the parties can be maintained and is verifiable.

In addition, either counterparty 3, 4 may provide an authorization 14 to a third-party 5, 6. The third-party 5, 6 may be, is currently, or is prospectively, providing services associated with the transaction 11 or another transaction. The authorization 14 may either be provided directly to computer 1 by counterparty 3, 4, or may be provided indirectly to the computer 1 by first providing it to the third-party 5, 6. The authorization may be provided to the computer 1 as an update 13 and may be recorded on the ledger 2 by the computer 1.

The authorization 14 may be used by the computer 1 to allow the associated third-party 5, 6 to view information regarding the transaction. In some embodiments, two or more authorizations 14 may be required, one from each counterparty 3, 4. The authorization 14 may indicate that only certain types of information regarding the transaction 11 is viewable for a third-party 5, 6. For example, payment terms, amounts, and dates may be visible to a financial third-party, but warranty information may not be visible.

When the authorization 14 is received by the computer 1, the computer may send a non-disclosure agreement to the third-party 5, 6 before permitting access to any information about the transaction 11. The non-disclosure agreement may be specific to the transaction 11, or to at least one of the counterparties 3, 4. The third-party 5, 6 may accept the non-disclosure agreement by providing an update 13 to the computer 1, which will be recorded on the ledger 2. The update 13 accepting the non-disclosure agreement may be provided by clicking a link provided to the third-party 5, 6 or selecting a checkbox.

In one embodiment with a public blockchain, to add a third-party 5, 6 a new update is recorded and encrypted such that it will be accessible to the third-party 5, 6. The new update includes all information that will be visible to the third-party 5, 6. The update may be generated by the computer 1. If a hybrid or private blockchain is used, permissioned accessed may be granted to the third-party 5, 6 by the computer 1 upon receipt of the authorization 14.

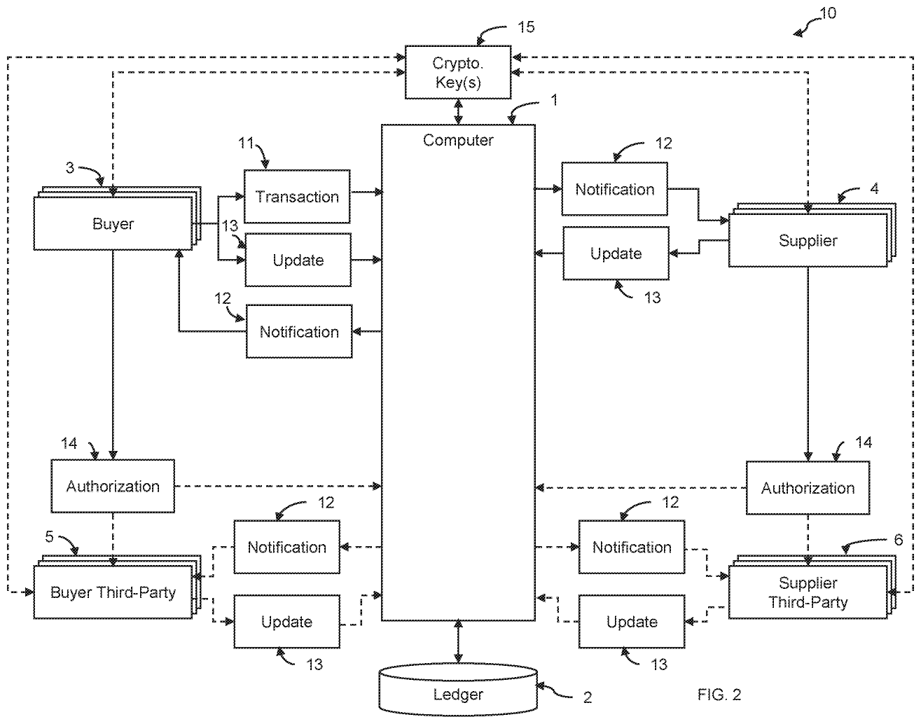

In FIG. 2, third-party notifications 12 and updates 13 are shown as being sent from and received by the computer 1. Third-parties 5, 6, may provide updates 13 indicative of a state of change to the transaction 11. Providing an update 13 as a third-party may follow the same procedure as providing an update 13 as a counterparty, and can include documents and/or other information. For example, a third-party shipping company may provide packing lists or other shipment confirmation updates 13 to the computer 1. The computer 1 may record these updates 13 as it would updates 13 from the counterparties 3, 4 and provide notifications 12 to counterparties 3, 4 based thereon. Update 13 from third-parties 5, 6 may also be indirectly to computer 1 through counterparties 3, 4.

Third-party notifications 12 may be received for types of information accessible to the third-party 5, 6. A notification 12 need not be immediately sent. For example, a notification 12 may be viewable at a set time, or at the request of a counterparty 3, 4.

FIG. 2 shows cryptographic keys 15 being exchanged as necessary between the computer 1, buyer 3, supplier 4, buyer third-party 5, and supplier third-party 6. As discussed above, encryption may be performed using any known cryptographic method, including public/private key cryptography. To that end, each of the counterparties 3, 4, third-parties 5, 6, and the computer 1 may exchange and use existing cryptographic keys 15 as necessary for encryption. The computer 1 can perform all encryption and decryption by generating, storing, recalling, and using all necessary keys, or by using keys provided by the counterparties 3, 4 and third-parties 5, 6. In this way, encryption and decryption can be transparent to the counterparties 3, 4 and third-parties 5, 6. In addition, the counterparties 3, 4 and third-parties 5, 6 may provide or receive necessary cryptographic keys 15 from the computer 1. For instance, a computer may provide a cryptographic key 15 to a supplier 4 when the computer sends a notification 12 of a new transaction 11. The computer may also provide cryptographic keys 15 to third-parties 5, 6 upon receipt of an authorization 14.

Transaction 11 may be one of many transactions between the counterparties 3, 4. In those cases, each transaction 11 may be related to one another on the ledger, such that a complete history between the parties is available for reference. This can be useful, for instance, in showing the counterparties' historical pricing, payment, and fulfillment.

In embodiments where buyers and suppliers 3, 4 have many transactions, they may be grouped and viewed as a whole, in order to determine a single net payment.

In some embodiments, buyers and suppliers 3, 4 may perform both roles for different transactions. The present system 10 is flexible and needs not place limitations on the type of information provided by the counterparties 3, 4. Accordingly, each transaction 11 can swap the counterparties in that buyers become suppliers and vice versa. In addition, the system 10 may allow counterparties 3, 4 to act as both suppliers and buyers in the same transaction 11.

In some embodiments, the transaction 11 may be fractionalized. In this case, there may be multiple buyers 3, suppliers 4 and/or third-parties 5, 6. Each of the buyers' 3, suppliers' 4 and/or third-parties' 5, 6 partial interests may be received by the computer 1 as part of a transaction 11 or update 13 and recorded on the ledger 2.

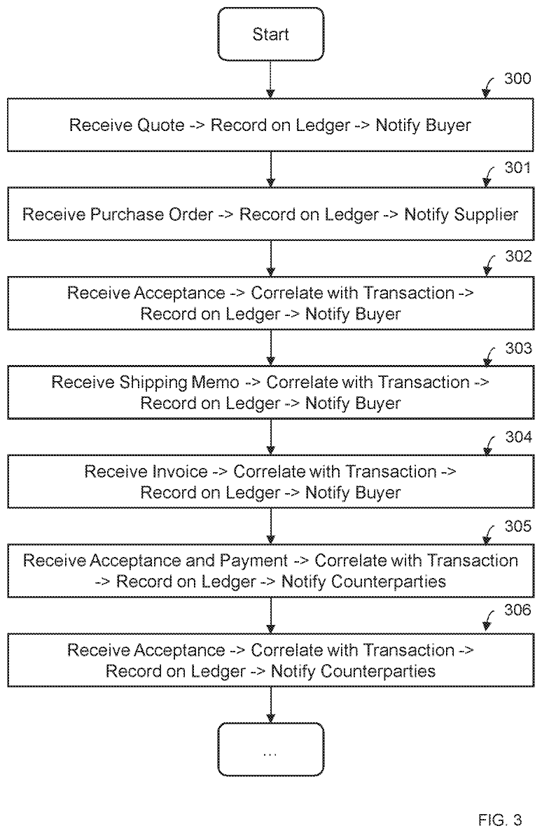

Referring to FIG. 3, a flowchart for the system of FIG. 1 is disclosed. In step 300, the computer 1 receives a transaction 11 in the form of a quote from a supplier 4. The computer 1 records the transaction 11 (including the purchase order information) on the ledger 2. The computer then notifies the buyer 3.

In step 301, the computer 1 receives an update 13 from the supplier 4, indicating that the buyer 3 issued a purchase order. The computer 1 records the update 13 on the ledger 2 in a manner relating it to the transaction 11. The computer 1 then notifies the supplier 4.

In step 302, the computer 1 receives an update 13 from the supplier 4, indicating that the supplier accepts the purchase order. The computer 1 records the update 13 on the ledger 2 in a manner relating it to the transaction 11. The computer 1 then notifies the buyer 3 of the acceptance.

In step 303, the computer 1 receives an update 13 from the supplier 4 indicative of a shipping memo related to the transaction. The computer 1 correlates the update 13 with the transaction 11, records the update 13 on the ledger 2, and notifies the buyer 3.

In step 304, the computer 1 receives an update 13 from the supplier 4 indicative of an invoice related to the transaction. The computer 1 correlates the update 13 with the transaction 11, records the update 13 on the ledger 2, and notifies the buyer 3.

In step 305, the computer 1 receives an update 13 from the buyer 3 accepting the shipping memo and invoice, and indicative of a payment confirmation related to the transaction. The computer 1 correlates the update 13 with the transaction 11, records the update 13 on the ledger 2, and notifies the counterparties 3, 4.

In step 306, the computer 1 receives an update 13 from the supplier 4 acknowledging receipt of the payment. The computer 1 correlates the update 13 with the transaction 11, records the update 13 on the ledger 2, and notifies the counterparties 3, 4.

Correlation of a specific update 13 with a transaction 11 may involve matching a value provided with the update 13 with a value associated with the transaction 11 or a value associated with a previous update 13.

While step 305 is the last step associated with FIG. 3, additional steps are possible. For instance, the counterparties may wish to record and accept warranty information. In addition, the counterparties may wish to allow third-parties to view the transaction, or revisit the transaction themselves.

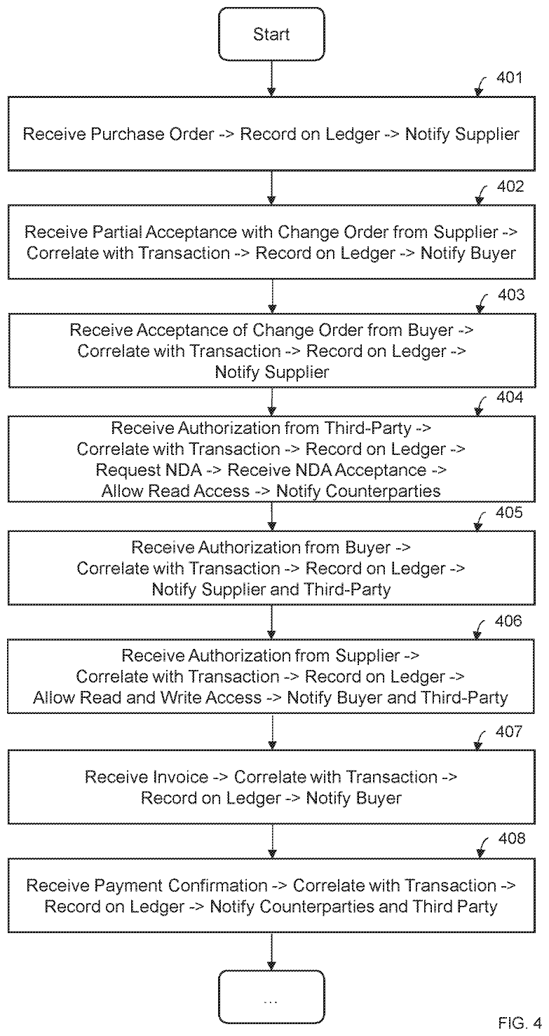

Regarding FIG. 4, in step 401, the computer 1 receives a transaction 11 in the form of a purchase order from a buyer 3. The computer 1 records the transaction 11 (including the purchase order information) on the ledger 2. The computer 1 then notifies the supplier 4.

In step 402, the computer 1 receives an update 13 from the supplier 4, indicating a partial acceptance of the purchase order. The partial acceptance proposes a change in price and quantities. The computer 1 records the update 13 on the ledger 2 in a manner relating it to the transaction 11. The computer 1 then notifies the buyer 3.

In step 403, the computer 1 receives an update 13 from the buyer 3 indicative of an acceptance of the change to the purchase order. The computer 1 records the update 13 on the ledger 2 in a manner relating it to the transaction 11. The computer 1 then notifies the supplier 4.

In step 404, the computer 1 receives an update 13 from the third-party 6 indicative of a third-party authorization 14 from the supplier 4. The authorization indicates that the third-party may view financial details of the transaction. The computer 1 records the authorization 14 on the ledger 2 in a manner relating it to the transaction 11. The computer sends a notification 12 to third-party 6 requesting that the third-party 6 agree to a non-disclosure agreement. The computer 1 receives an update from third-party 6 indicating that the third-party 6 agrees to the non-disclosure agreement. The computer 1 provides read access to financial details of the transaction 11 to third-party 6. The computer 1 then notifies the buyer 3 and supplier 4.

In step 405, the computer 1 receives an update 13 from the buyer 3 indicative of a third-party authorization 14 for third-party 5. The authorization 14 indicates that a third-party 5 may view and update shipment details of the transaction upon acceptance of supplier 4. The computer 1 records the update 13 on the ledger 2 in a manner relating it to the transaction 11. The computer 1 then notifies the supplier 4 and third-party 5.

In step 406, the computer 1 receives an update 13 from the supplier 4 accepting the third-party authorization 14 for third-party 5. The computer 1 records the authorization 14 on the ledger 2 in a manner relating it to the transaction 11. The computer provides read and write access to shipment details of the transaction 11 to third-party 5. The computer 1 then notifies the buyer 3 and supplier 4.

In step 407, the computer 1 receives an update 13 from the supplier 4 indicative of an invoice related to the transaction. The computer 1 correlates the update 13 with the transaction 11, records the update 13 on the ledger 2, and notifies the buyer 3 and supplier 4.

In step 408, the computer 1 receives an update 13 from the buyer indicative of a payment confirmation related to the transaction. The computer 1 correlates the update 13 with the transaction 11, records the update 13 on the ledger 2, and notifies the supplier 4.

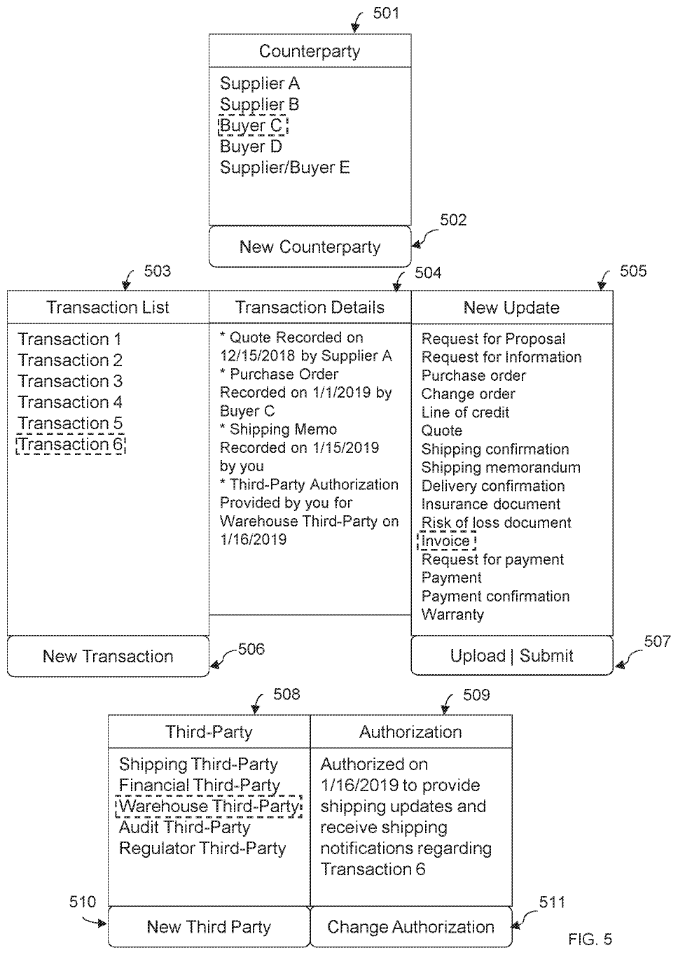

Regarding FIG. 5, a user interface of system 10 is shown from the perspective of a counterparty, referred to herein as Counterparty X.

In area 501, counterparties are shown and selectable. Suppliers A, B, Buyers C, D and Supplier/Buyer E all have recorded transactions with Counterparty X. By activating button 502, a new counterparty can be added.

In area 503, the list of transactions with the counterparty selected in area 501 are listed and selectable. New transactions may be added by selecting the button in area 506. By selecting a transaction in area 503, its details are shown in area 504. Updates may be provided for the transaction using the menu shown in area 505. Documents associated with the update may be uploaded by selecting the button in area 507. With or without an uploaded document, the update may be submitted by selecting the button in area 507.

In area 508, third-parties associated with the counterparty selected in area 501 and/or the transaction selected in area 503 are listed and selectable. New third-parties may be added by selecting the button in area 510. By selecting a third-party in area 508, its authorizations are shown in area 509. Authorizations may be modified by selecting the button in area 511.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system facilitating purchase and sales transactions comprising:
a computer;
a ledger database in data communication with said computer;
a transaction received by said computer;
software executing on said computer for recording the transaction on the ledger;
a notification indicative of the transaction transmitted by said computer to at least one counterparty;
an update indicative of a change to the transaction received by said computer;
software executing on said computer for relating the update with the transaction;
software executing on said computer for recording the update on the ledger in a manner relating it to the transaction; and
a second notification indicative of the updated transaction transmitted by said computer to at least one counterparty.

2. The system of claim 1, wherein the transaction is at least one of a request for proposal, a request for information, and a purchase order.

3. The system of claim 1, wherein the update is at least one of a change order, a line of credit, a quote, a shipping confirmation, a shipping memorandum, a delivery confirmation, an insurance document, a risk of loss document, an invoice, a request for payment, a payment confirmation, a payment, and a warranty.

4. The system of claim 1, wherein the update indicates an acceptable of the transaction.

5. The system of claim 1, wherein the update indicates a rejection of the transaction.

6. The system of claim 1, wherein at least one of a buyer identity, a supplier identity, a third-party authorization, and a timestamp is recorded on the ledger with the transaction.

7. The system of claim 1, wherein an authorization regarding a third-party is received by the computer.

8. The system of claim 7, further comprising:
a second update indicative of a change to the transaction is received by said computer;
software executing on said computer for recording the second update on the ledger in a manner relating it to the transaction; and
a third notification indicative of the updated transaction transmitted by said computer to at least one counterparty.

9. The system of claim 7, further comprising software executing on said computer for providing at least one of the transaction or the update to the third-party.

10. The system of claim 7, further comprising:
software executing on said computer for transmitting a non-disclosure agreement to said third-party;
a second update indicative of an acceptance of the non-disclosure agreement received by said computer;
software executing on said computer for recording the second update on the ledger in a manner relating it to the transaction; and
a third notification indicative of the second update transmitted by said computer to at least one counterparty.

11. The system of claim 1, wherein the ledger is a public blockchain.

12. The system of claim 1, wherein the ledger is a hybrid blockchain.

13. The system of claim 1, wherein the ledger is a private blockchain.

14. The system of claim 1, wherein at least one of the transaction and the update is encrypted.

15. The system of claim 1, wherein the transaction indicates fractional interests held by at least two counterparties.

16. The system of claim 1, further comprising:
a second update indicative of a fractional interest received by said computer;
software executing on said computer for recording the second update on the ledger in a manner relating it to the transaction; and
a third notification indicative of the second update transmitted by said computer to at least one counterparty.
